(19) United States
(12) Patent Application Publication
(10) Pub. No.: US 2009/0047403 A1
(43) Pub. Date: Feb. 19, 2009

(54) Pomegranate processing machine

(76) Inventor: Rodney A. Lyon, Newcastle, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 11/893,271

(22) Filed: Aug. 14, 2007

(51) Int. Cl. A23N 7/02; A23L 1/212

(52) U.S. Cl. 426/483; 99/625

(57) ABSTRACT

The machine removes skins from a pomegranate or other fruit or vegetable. A pair of belts are spaced apart by a gap. The belts travel in a common direction adjacent the gap and are closer together on at least portions thereof than a width of the pomegranate. Pomegranates passed through the gap are thus compressed between the two belts. One of the belts travels faster than the other belt so that both compression and a shearing force act upon the skin of the pomegranate. The skin is torn and opened to expose arils within a core of the pomegranate. An under belt preferably carries pomegranates through the gap with slots in the under belt to allow arils and juice to fall down through an opening in a deck upon which the compression belts are mounted. A tray collects the arils and juice falling through the deck below the gap.

### FIELD OF THE INVENTION

The following invention relates to machines for processing fruits or vegetables, of a type which remove skins or other outer surfaces of the fruits and vegetables. More particularly, this invention relates to fruit and vegetable processing machines which engage and tear skins or outer surfaces from a fruit or vegetable, for instance a pomegranate, to expose interior contents of the fruit or vegetable, such as for removal of interior contents from a skin or outer surface thereof.

### BACKGROUND OF THE INVENTION

Pomegranates (punica granatum) have been known since antiquity, including reference in the Bible's book of Exodus, from approximately 1400 B.C. (over 3,400 years ago). Pomegranates are the fruit of a small deciduous tree native to Asia having a tough reddish skin (also called a rind) and containing many seeds each enclosed in a juicy, mildly acidic pulp jacket, referred to as an aril. This pulp jacket as well as the seed are edible, while the skin and thicker pulp layers between the arils are not generally edible or at least desirable for consumption.

Pomegranates are primarily enjoyed two different ways. First, the juice contained in each aril can be extracted, such as by crushing the arils and collecting the juice. This juice can be consumed in pure form, mixed with other juices, or is also known to be concentrated and bottled. The most common form of such pomegranate concentrate is often referred to as grenadine syrup. A second way to enjoy pomegranates is to eat the arils fresh, so that the juice of the aril is released during the eating process. Such arils can be consumed alone or can be provided as a topping on a salad or other comestible, or otherwise mixed with other food items.

Pomegranates have heretofore been difficult to process for consumption. To obtain juice, while a simplest strategy might be to merely press the whole pomegranate to extract the juice, such pressing can cause undesirable liquids within the skin or pulp to simultaneously be extracted and add a bitter undesirable quality to the juice. Hence, it is typically necessary to first remove at least the skin before such pressing can effectively occur. In the prior art, removal of the pomegranate from the skin has not been particularly successfully achieved in an automated fashion. Hence, hand removal of the skin is often required.

Two prior art attempts at automated processing of pomegranates include U.S. Pat. No. 4,530,278 to Sarig and U.S. Pat. No. 5,537,918 to Patel. The patents to Sarig and Patel utilize machinery to extract seeds or juice from the pomegranate, and utilize structures other than conveyor belts to handle the pomegranates. Sarig and Patel also fail to teach removal of the skin, such that the advantages associated with an initial step of separating the skin from the arils and pulp of the pomegranate is not enjoyed with these prior art machines.

When whole arils are to be separated for further processing, typical prior art juicing devices are not adequate. In particular, such juicing devices typically use different crushing elements or other elements which apply compression or shear forces upon the juice containing structures within the fruit, such as the outer surface of the aril, to rupture the aril and release juice therefrom. Hence, such juicing machinery is not useful in preserving the aril intact with the juice remaining within the outer surface of the aril along with the seed.

Accordingly, a need exists for a pomegranate processing machine which can enhance the efficiency with which an outer skin is removed from a pomegranate and which can facilitate removal of arils from the skin and pulp of the pomegranate without a large portion of the arils being crushed or otherwise damaged.

### SUMMARY OF THE INVENTION

With this invention a machine is provided for processing of pomegranates which mechanically removes the skin from the pomegranate and opens up an interior of the pomegranate to at least partially separate arils within the pomegranate from the skin and associated pulp, in a manner which leaves a large percentage of the arils intact and undamaged for further processing. The machine includes at least two belts which are spaced from each other by a gap therebetween. The belts, referred to as the side belt and the pincher belt, travel in a common direction from an input of the machine to an exit of the machine with the gap extending between the input and the exit. Portions of this gap are sufficiently narrow that they are narrower than a width of a smallest pomegranate to be processed.

Most preferably, an under belt is also provided which extends from the input to the exit beneath the gap. The under belt thus acts to convey the pomegranate from the input to the exit and along the gap between the side belt and the pincher belt. The side belt and pincher belt preferably move in a common direction adjacent the gap in a direction extending from the input to the exit. The under belt also preferably travels in this same direction. Hence, all of the belts encourage the pomegranates placed within the input to travel from the input to the exit.

The pomegranates are most preferably preprocessed to provide a flat undersurface and to cut away a top portion of the pomegranate. Thus, the preprocessing causes the pomegranate to have a somewhat cylindrical form with a central axis that can be oriented vertically within the gap and between the side belt and pincher belt having a height of typically about two to three inches. The pomegranates maintain their original diameter in a generally circular form and typically 2½ to 3½ inches in diameter. The gap preferably starts with a width wider than a largest pomegranate and transitions narrower to a width of approximately one to two inches and narrower than a width of a smallest pomegranate to be processed. This width can be adjustable either for each pomegranate or can be adjusted for various different lots of pomegranates that have been pre-sized so that a proper amount of compression on each pomegranate occurs.

Uniquely, the pincher belt (or the side belt) travels faster than the side belt. With the pincher belt traveling faster than the side belt, and with the pincher belt and side belt spaced apart from each other by a gap that is narrower than a width of the pomegranate, the pomegranate is simultaneously laterally compressed by the belts and the pincher belt's greater speed causes a shearing force to be applied to the skin on the side of the pincher belt in a direction extending toward the exit of the machine.

The side belt and pincher belt have sufficient frictional engagement with the skin that friction forces keep the pomegranate from substantially sliding or rolling. Rather, the pincher belt grips the skin and tears the skin. The skin, which starts with a cylindrical form, is torn and then peeled off of the core (including the arils and pulp within the pomegranate) to take on a final elongate somewhat rectangular form.

Because the skin is somewhat attached to interior arils and pulp, as the skin is torn and converted from a circular/cylindrical form into an elongate/rectangular form, portions of the arils and pulp are opened up and separated from each other and from the skin. These freed arils and clumps of aril and pulp combined, having been opened up and released from the skin, can fall down from the gap and collect within a tray for further processing, the tray located underneath the gap.

With the under belt preferably provided below the gap, this under belt preferably includes a series of bars with slots therebetween. The slots are sufficiently large so that individual arils and clumps of arils or arils and pulp can fall together down through the slots in the under belt to fall down into the tray. Further processing can then occur to remove the arils from remaining pulp. Also, any juice associated with crushed arils and occurring within the machine would also fall down into the tray and can be salvaged with a minimum of undesirable liquids from the skin contained within any such juice.

Most preferably, the pair of belts are mounted on an upper surface of a deck with the under belt having upper portions thereof which support the pomegranates passing through the gap and resting upon the deck, but with an opening formed in the deck beneath the gap sufficiently large to allow the arils and combinations of arils and pulp and juice to fall down through the deck for collection in the tray beneath the deck. At an exit of the machine, a slide is preferably provided which encourages skins and any large clumps of arils and pulp to come off of the under belt and slide down away from the tray where they can be separately collected for potential further processing to remove arils and/or pulp from skin or from each other in later processing operations.

Each of the belts preferably is driven by pulleys and each of the belts is preferably in a form including bars with slots therebetween, with the bars passing between parallel chains extending around ends of the pulleys. Motors drive each of the belts with appropriate drive motors to cause the desired speed differentials between the side belt and pincher belt.

While this invention is particularly configured to be effective in removing skins from pomegranates, and to facilitate the collection of whole arils and pomegranate juice without also extracting undesirable liquids from the skin, and without requiring human intervention, this machine might also have some utility with other fruits and vegetables either closely related to pomegranates or less so related.

### OBJECTS OF THE INVENTION

Accordingly, a primary object of the present invention is to provide a machine for removing skins from a pomegranate and for separation of whole arils and/or juice from other portions of the pomegranate.

Another object of the present invention is to provide a machine which can remove a skin from a pomegranate without significant release of undesirable liquids within the skin.

Another object of the present invention is to provide a machine which separates whole arils from a skin and some pulp of a pomegranate without crushing or otherwise damaging a large portion of the arils.

Another object of the present invention is to provide a pomegranate processing machine which extracts both arils and pomegranate juice from a pomegranate in an automatic fashion.

Another object of the present invention is to provide a pomegranate processing machine which can extract arils and/or juice from a pomegranate and which can accommodate pomegranates of a variety of different sizes.

Another object of the present invention is to provide a fruit or vegetable processing machine which removes at least portions of a skin of a fruit for separation of the skin from interior portions of the fruit.

Another object of the present invention is to provide a process for removing a skin from a pomegranate.

Another object of the present invention is to provide a process for opening up a core of a pomegranate to free arils from the skin and pulp of the pomegranate.

Another object of the present invention is to provide an apparatus for separating at least some skin portions of a fruit from interior portions of a fruit in an automatic fashion.

Other further objects of the present invention will become apparent from a careful reading of the included drawing figures, the claims and description of the invention.

### BRIEF DESCRIPTION OF THE DRAWINGS

FIG. 1 is a perspective view of the pomegranate processing machine of this invention shown in use with a pomegranate having just entered an input of the pomegranate processing machine and showing one skin exiting the exit of the pomegranate processing machine.

FIG. 2 is a side elevation view in section of that which is shown in FIG. 1 and illustrating the location of an aril and juice collection tray beneath the gap between opposing belts (only one of which is shown), of the pomegranate processing machine, and showing pomegranates passing through the gap and undergoing a processing method according to this invention. Pulleys supporting the belt shown are illustrated with hidden lines.

FIG. 3 is a top plan view of a deck forming a portion of the machine of this invention and with belt portions of the machine outlined in broken lines.

FIG. 4 is an end elevation full sectional view taken along lines 4-4 of FIG. 6 and generally depicting an end view looking from an exit of the pomegranate processing machine toward an entrance of the pomegranate processing machine, and through a gap between the side belt and pincher belt of this invention.

FIG. 5 is an end view of that which is shown in FIG. 1 looking through a gap between the side belt and a pincher belt of this invention from an exit toward an input thereof.

FIG. 6 is a top plan view of that which is shown in FIG. 1 and with a pomegranate shown being conveyed through a gap thereof.

FIG. 7 is a detail of a portion of that which is shown in FIG. 6 and with multiple pomegranates shown at various stages of processing utilizing the machine of this invention and according to the method of this invention.

FIG. 8 is a front elevation view of a pomegranate before pre-preparation and showing cut lines along which a pomegranate is typically cut before utilization of the machine of this invention.

FIG. 9 is a front elevation view of a pomegranate after having been cut in a procedure immediately before processing of the pomegranate within the machine of this invention.

FIG. 10 is a top plan view of that which is shown in FIG. 9 and showing generally how a skin of the pomegranate begins with a circular form and surrounds a perimeter of the fruit with the arils contained inside.

### DESCRIPTION OF THE PREFERRED EMBODIMENT

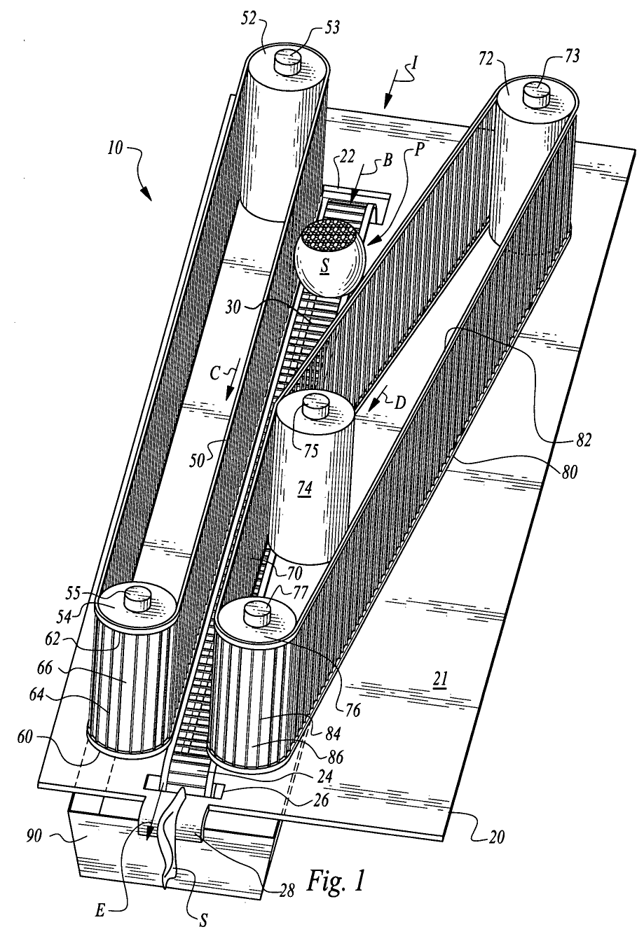

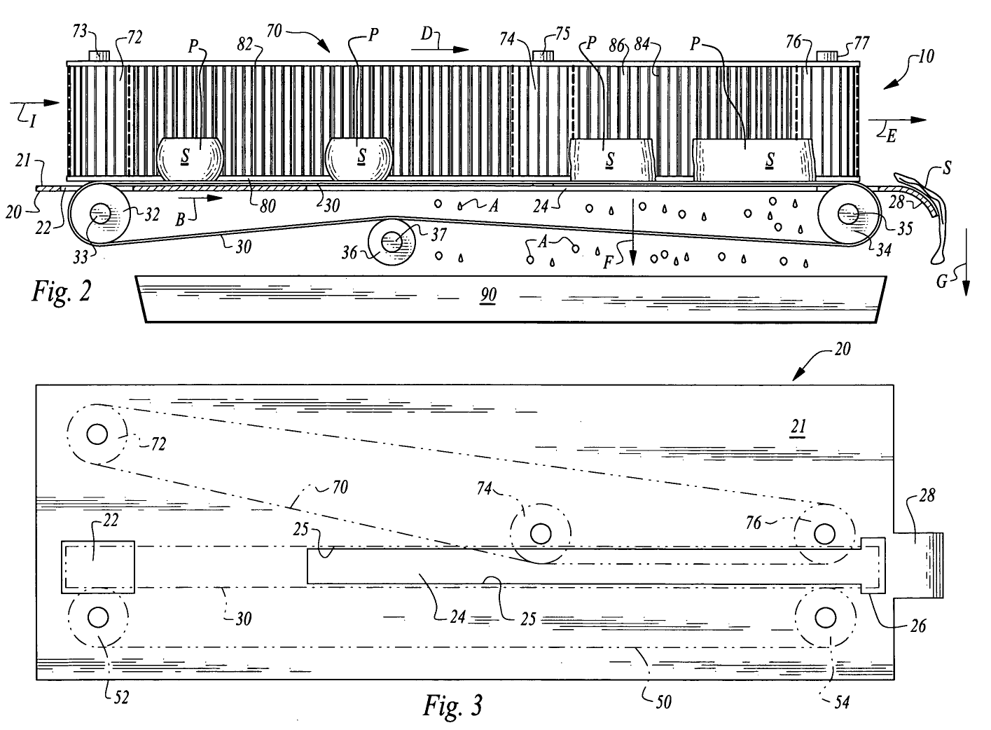

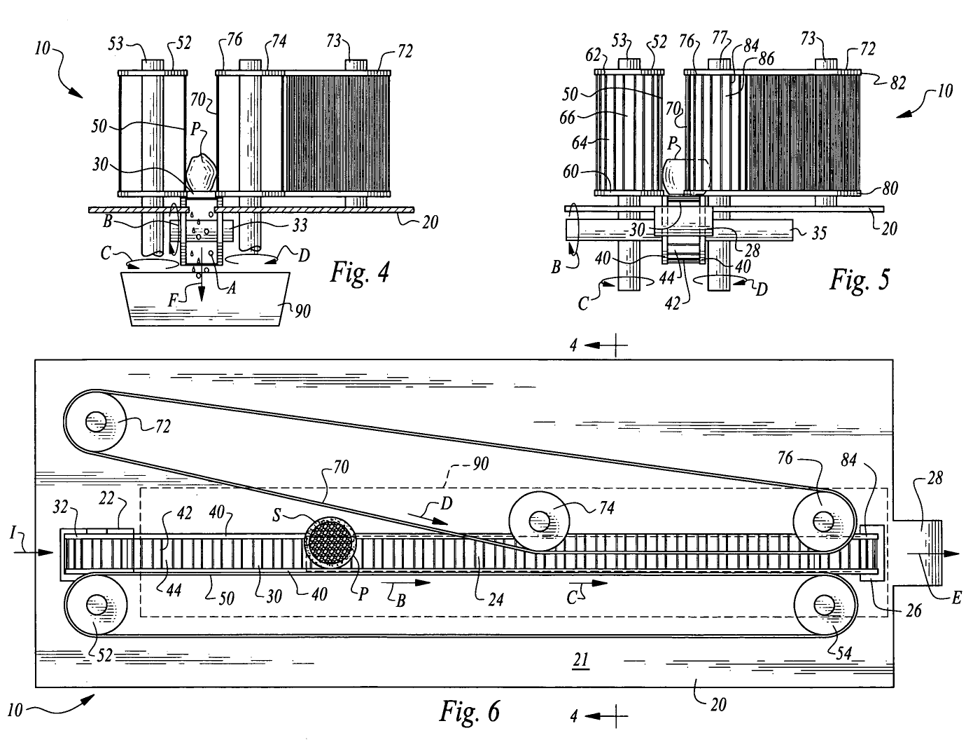

Referring to the drawings, wherein like reference numerals represent like parts throughout the various drawing figures, reference numeral 10 is directed to a pomegranate processing machine (FIGS. 1, 2 and 4-6). While the machine 10 could be utilized for removal of skins S from fruits or vegetables other than pomegranates P, the machine 10 is particularly configured for pomegranate P processing. The pomegranates P pass through the machine 10 and have a skin S thereof torn and peeled from the arils A within the pomegranate P. The arils A and juice can then fall down (along arrow F of FIG. 2) for collection within a tray 90. The skins S are transported to an end of the machine 10 where they can fall down (along arrow G) into a region for further processing or disposal.

In essence, and with particular reference to FIG. 6, basic details of the pomegranate processing machine 10 of this invention are described according to a preferred embodiment. The machine 10 is preferably supported substantially entirely upon a deck 20. A gap is provided above the deck 20 and between a side belt 50 and a pincher belt 70. This gap extends from an input I to an exit E. An under belt 30 is preferably provided with portions thereof resting upon the deck 20. The under belt 30 is provided to convey pomegranates P from the input I to the exit E of the gap.

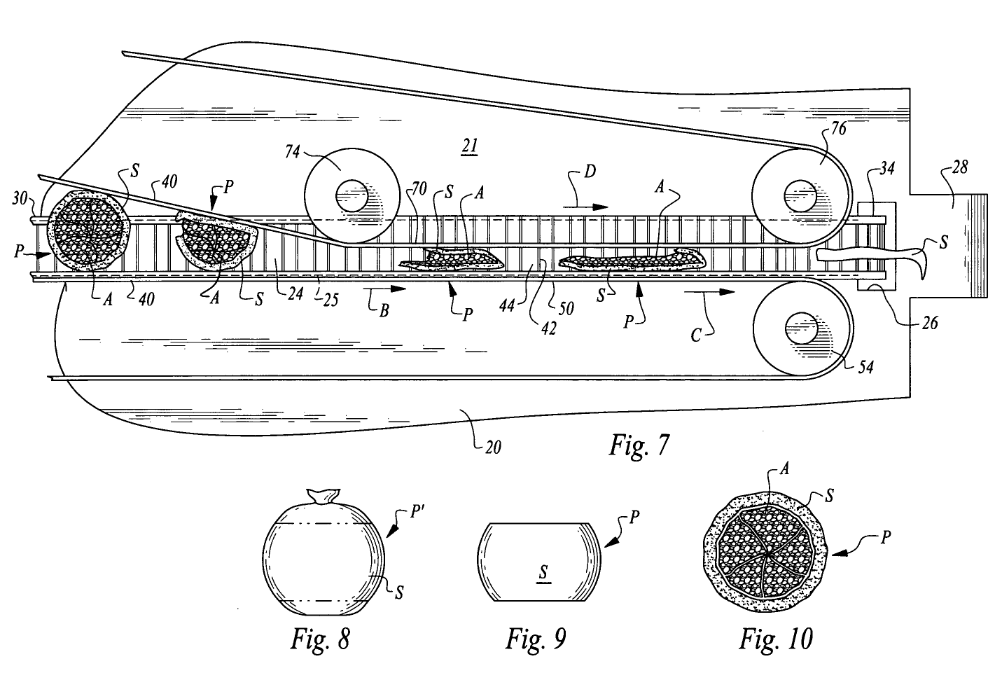

Each of the belts 30, 50, 70 is configured to rotate in a common direction adjacent the gap, so that pomegranates P are encouraged to pass through the gap from the input I to the exit E. The gap shrinks in size as it moves toward the exit E until a spacing between the side belt 50 and pincher belt 70 is less than a diameter of the pomegranate P. The pincher belt 70 moves at a faster speed than the side belt 50. Thus, when the pomegranate P is pinched between the side belt 50 and pincher belt 70, this speed differential applies a sheer force to the skin S of the pomegranate P, tending to tear and unwrap the skin S in a clockwise direction off of interior contents of the pomegranate P (FIG. 7). Arils A are thus liberated from a core of the pomegranate P and allowed to fall down through the under belt 30, through the deck 20 and for collection into the tray 90 (FIG. 2). The resulting skin S along with any remaining arils A leave the gap through the exit E (FIG. 2) where they can be collected for further processing or disposal.

More specifically, and with particular reference to FIGS. 1-7, basic details of the deck 20 are described according to a preferred embodiment. While the deck 20 is not strictly required for this processing machine, it conveniently provides a structure for supporting of other portions of the processing machine. The deck 20 and portions of the machine above the deck 20 are formed of materials that can be sanitized to food grade standards, such as stainless steel. The deck 20 is preferably a rigid planar structure having a planar substantially horizontal top surface 21 upon which other portions of the machine 10 are mounted. The deck 20 includes holes passing therethrough at positions where axles of the pulleys supporting the side belt 50 and pincher belt 70 are to be located. In this way drive mechanisms for the belts 30, 50, 70 can be located below the deck.

The deck 20 also includes various openings for accommodating the under belt 30. In particular, these openings include a lead opening 22 and a long opening 24. The lead opening 22 is almost square in form and directly above an upstream pulley 32 (FIG. 2) of the under belt 30. This lead opening 22 generally provides for portions of the under belt 30 to come off of the upstream pulley 32, pass through the lead opening 22 and up onto the top surface 21 of the deck 20 before moving toward the downstream pulley 34 of the under belt 30 (FIG. 2). The lead opening 22 is preferably slightly wider than the under belt 30 so that the under belt 30 can easily pass up through the lead opening 22. The lead opening 22 does not extend all the way to the long opening 24. Thus, the under belt 30 rests upon the top surface 21 and travels over the top surface 21 between the lead opening 22 and the long opening 24.

The long opening 24 has a length extending approximately three-quarters of the length of the deck 20 and from a region upstream of where the gap becomes narrower than a typical pomegranate P to where the exit E (FIGS. 1, 2 and 6) causes remaining portions of the pomegranate P to leave the gap. The long opening 24 is provided so that arils A, juice and any pulp attached to the arils A can fall down through the deck 20 for collection within the tray 90 (FIGS. 2-4). The long opening 24 has side edges 25 which are closer together than a width of the lead opening 22. In particular, the side edges 25 are preferably slightly closer together than a width of the under belt 30. In this way, the under belt 30 does not sag down into the long opening 24 but remains upon the top surface 21 of the deck 20 with edges of the under belt 30 remaining upon the top surface 21 of the deck 20 adjacent the side edges 25 of the long opening 24.

The long opening 24 has a wide end 26 at an end thereof opposite the lead opening 22. This wide end 26 has a width similar to the lead opening 22 and provides a short portion of the long opening 24 with a sufficient width to allow the under belt 30 to pass down through the deck 20 to pass around the downstream pulley 34 of the under belt 30.

The deck 20 preferably includes a slide 28 at an end of the deck 20 adjacent the exit E of the gap in the machine 10. This slide 28 has an arcuately curving portion that curves downwardly (FIGS. 1 and 2) and acts as a ramp for sliding of the skins S and any portions of the pomegranate P still attached to the skin S to fall down (along arrow G) away from the tray 90 for separate collection. This slide 28 preferably begins close enough to the under belt 30 and the long opening 24 in the deck 20 that the skins S will not fall down through the wide end 26 of the long opening 24 along with the under belt 30, but rather be encouraged to fall over the slide 28, along arrow G. In some instances, a skin S might become lodged resting upon the slide 28. In such a case, a second skin S of a falling pomegranate P can bump up against a first skin S and encourage it to pass along arrow G. Most typically, the skin S would include at least some arils A still coupled thereto. Further processing of the skin S can occur to remove such arils A, with such further processing beginning by having the skins S fall (along arrow G of FIG. 2) down into some further processing equipment.

With particular reference to FIGS. 1-7, specific details of the under belt 30 are described according to this preferred embodiment. The under belt 30 is provided in the preferred form of this invention to convey pomegranates P through the gap of the machine 10 for processing of the pomegranate P. The under belt 30 is not strictly required. For instance, the deck 20 could merely provide a surface along which pomegranates can slide and pomegranates P could be fed into the gap by hand or with a pushing tool to push pomegranates into a narrow portion of the gap where the side belt 50 and pincher belt 60 could then engage the pomegranates P to carry them on through the gap from the input I to the exit E.

Most preferably, however, the under belt 30 is provided to assist in conveying the pomegranates P along the gap in the machine 10. Another option for the under belt 30 is to angle the deck 20 so that the pomegranates would slide along the top surface 21 of the deck 20 slightly from the input I to the exit E, with sufficient slope on the deck 20 that pomegranates P would be encouraged by gravity to pass through the gap from the input I to the exit E.

The under belt 30 preferably includes an upstream pulley 32 rotating upon an axle 33 which extends substantially horizontally and perpendicular to a direction of pomegranate P travel from the input I to the exit E. The under belt 30 also includes a downstream pulley 34 with an axle 35 parallel with the axle 33 and located adjacent the wide end 26 of the long opening 24 in the deck 20. Both of these pulleys 32, 34 are located below the deck 20 and with a diameter similar to half of a distance that the axles 33, 35 are located below the deck 20. In this way, uppermost portions of the pulleys 32, 34 are even with the openings 22, 24 in the deck 20.

Most preferably, a tension pulley 36 is also provided between the upstream pulley 32 and downstream pulley 34. The tension pulley 36 preferably rotates about an axle 37 parallel with the upstream axle 33 and downstream axle 35. The tension pulley 36 preferably does not have the under belt 30 wrapped around the tension pulley 36, but rather is merely interposed in a path for a portion of the under belt 30 beneath the deck 20 to maintain tension on the under belt 30. This tension pulley 36 can have its axle 37 on a spring loaded or adjustable mount so that spring forces or position adjustment can move the tension pulley 36 vertically up or down to adjust a tension on the under belt 30.

The under belt 30 is formed of a pair of side chains 40 with a plurality of bars 42 extending perpendicularly between the two side chains 40. Slots 44 are provided between adjacent bars 42 to form the under belt 30. The side chains 40 are preferably spaced apart a distance similar to a width of the pulleys 32, 34. The bars 42 are spaced apart sufficiently so that individual arils A and clumps of arils A and clumps of combinations of arils A and pulp can readily fall down through the slots 44 for collection within the tray 90. However, the slots 44 are sufficiently narrow that whole pomegranates P and pomegranate skins S do not fall down through the slots 44. One typical spacing for the bars 44 is to have the slots 44 have a width of approximately one-half inch.

As shown in FIG. 3, the side chains 40 remain at least partially supported upon the top surface 21 as they pass between the lead opening 22 and the wide end 26 of the long opening 24. While the under belt 30 is passing over the long opening 24, the bars 42 pass over the long opening 24 between the two side edges 25 of the long opening 24, so that arils A and juice falling through the slots 44 further fall through the long opening 24 for collection within the tray 90.

With particular reference to FIGS. 1 and 3-7, details of the side belt 50 are described. The side belt 50 preferably provides one of a pair of belts which are spaced apart by the gap between the input I and exit E of the machine 10 and engage the pomegranate P during processing thereof. The side belt 50 is removed from FIG. 2 for clarity, but is otherwise shown in FIGS. 1-7. The side belt 50 preferably has a configuration generally similar to that of the under belt 30, except that pulleys thereof are longer and the orientation of the side belt 50 is perpendicular to that of the under belt 30.

In particular, the side belt 50 preferably includes a pair of pulleys including input pulley 52 adjacent the input I and an exit pulley 54 adjacent the exit E. The input pulley 52 rotates about an axle 53 and the exit pulley 54 rotates about an axle 55. The axles 53, 55 preferably extend vertically and parallel to each other and perpendicular to the deck 20 and perpendicular to the axles 33, 35 of the pulleys 32, 34 of the under belt 30.

The side belt 50 preferably includes a bottom chain 60 spaced from a top chain 62 by a distance similar to a height of the input pulley 52 and exit pulley 54. Bars 64 extend between the bottom chain 60 and top chain 62 with slots 66 between adjacent bars 64. These slots 66 are most preferably 3/8 inch wide. The bottom chain 60 most preferably rests upon the top surface 21 of the deck 20 or is just slightly above the top surface 21 to minimize friction. In one embodiment, the bottom chain 60 can rest directly upon one of the side chains 40 of the under belt 30. However, the perpendicular orientation of the pulleys 32, 34 and the pulleys 52, 54 of the under belt 30 and side belt 50 cause the bottom chain 60 and side chain 40 to only be adjacent each other for a portion of their pathways. The side belt 50 preferably moves at a common speed with the under belt 30.

With particular reference to FIGS. 1-7, details of the pincher belt 70 are described according to a preferred embodiment. The pincher belt 70 preferably provides a second one of the pair of belts spaced apart by the gap and acting upon pomegranates P within the gap for processing thereof. The pincher belt 70 is preferably routed around three pulleys including a front pulley 72, a pincher pulley 74 and a rear pulley 76.

The front pulley 72 is closest to the input I and rotates about an axle 73. The pincher pulley 74 is midway between the front pulley 72 and rear pulley 76 and causes the pincher belt 70 to approach close enough to the side belt 50 to pinch pomegranates P between the pincher belt 70 and the side belt 50. The pincher pulley 74 rotates about an axle 75. The rear pulley 76 is located adjacent the exit pulley 54 of the side belt 50 and closest to the exit E of the machine 20. The axles 73, 75, 77 of the pincher belt 70 are preferably each parallel to each other and extend in a vertical direction perpendicular to the top surface 21 of the deck 20.

The pincher belt 70 is preferably elevated slightly above the deck 20 so that it does not come into contact with the deck 20 or any portions of the under belt 30. The pincher belt 70 includes a lower chain 80 elevated slightly above the top surface 21 and spaced from an upper chain 82. Bars 84 extend from the lower chain 80 to the upper chain 82 and generally perpendicular to the lower chain 80 and upper chain 82. Slots 86 are located between adjacent bars 84 in the pincher belt 70. Preferably, spacing between the bars 84 of the pincher belt 70 is similar to spacing between bars 64 of the side belt 50. The spacing can be similar to that of the bars 42 in the under belt 30 if desired, or could be closer together.

These bars 84 are typically cylindrical in form, but could have a square or other polygonal cross-section to provide edges or other engagement structures to more successfully grip skins S of pomegranates P passing through the gap between the side belt 50 and pincher belt 70. The pincher belt 70 makes an approximately 90° turn around the front pulley 72 and the rear pulley 76. The pincher belt 70 travels past the pincher pulley 74 while only making an approximately 15° bend while passing around the pincher pulley 74.

In use and operation, the method of use of the pomegranate processing machine 10 is described according to a preferred embodiment. Initially, when pomegranates P′ are to be processed it is initially preferably desirable that the pomegranate P′ be preprocessed. Such preprocessing generally includes cutting the pomegranate P′ along two horizontal planes above and below a centerline of the pomegranate P′. Cutting lines are depicted in FIG. 8 illustrating how the pomegranate P′ is to be initially cut. After cutting, the pomegranate P has a more cylindrical form, but is actually both cylindrical in some respects and spherical in some respects as depicted in FIGS. 9 and 10. FIG. 10 shows a top plan view of the pomegranate P after having been preprocessed. At least portions of arils A within the pomegranate P are typically visible after this preprocessing step.

The skin S is generally in the form of a cylindrical ring girding a core of the pomegranate P containing the arils A and pulp therein. The pomegranate P is now ready for passing into the machine 10. As best shown in FIGS. 1 and 6, pomegranates P are first placed into the machine 10 by placement upon the under belt 30 adjacent the input I. The under belt 30 travels (along arrow B of FIGS. 1, 2, 6 and 7) from the input I toward the exit E. Because the side belt 50 is directly adjacent the under belt 30 and travels at a common speed (along arrow C of FIGS. 1, 6 and 7), the pomegranates P are typically also abutting the side belt 50 as they travel past the input I and through the gap between the side belt 50 and pincher belt 70. The gap 50 begins excessively wide so that the pomegranate P is only contacting the side belt 50. The under belt 30 is typically narrower than a diameter of the pomegranate P so that portions of the pomegranate P might initially hang off of the under belt 30 (FIGS. 6 and 7).

When the pomegranate P travels sufficiently from the input I toward the exit E that the pincher belt 70 comes into contact with the skin S of the pomegranate P, the pomegranate P begins to be compressed laterally between the side belt 50 and pincher belt 70. The pincher belt 70 travels along arrow D (FIGS. 1, 2, 6 and 7) at a speed greater than that of the side belt 50. As one example, the pincher belt 70 can travel ten percent to twenty percent faster than the side belt 50. Thus, the pincher belt 70 exerts both a compressing and shearing force simultaneously upon the skin S of the pomegranate P. This combination of compression and shearing forces causes the pomegranate P to be collapsed from a generally circular cross-section (FIG. 7) to a somewhat flattened cylindrical form.

The greater speed of the pincher belt 70 also causes the skin S to tear typically along a somewhat vertical tear line on a trailing portion of the skin S. The skin S is then rotated generally in a clockwise direction until the skin S has been laid flat in a plane somewhat parallel with portions of the side belt 50 and pincher belt 70 adjacent the gap (FIG. 7). The gap is preferably between one-half inch and three inches wide, most typically two inches wide, in a narrowest portion of the gap. Typical pomegranates are between four and five inches in diameter.

This rolling open of the pomegranate P causes arils A within the pomegranate P to be at least partially released from the skin S. These arils A can then fall down (along arrow F of FIG. 2) through the under belt 30 and down into the tray 90 for collection. The juice from crushed arils A can also fall down through the under belt 30 and through the deck 20 for collection within the tray 90. Some pulp will typically also fall with the arils A and juice down into the tray 90 where further processing can remove such pulp from the arils A and juice. Finally, the skin S and any remaining arils A exit the machine at the exit E where they slide over the slide 28 and fall (along arrow G of FIG. 2) for collection and potential further processing.

While the belts 30, 50, 70 can be driven by separate motors, they could also be driven by a common motor with different gear ratios provided to provide the differential speeds required for the different belts 30, 50, 70. Most preferably, the pincher belt 70 is traveling just enough faster than the side belt 50 that the skin S of the pomegranate P is caused to rotate approximately half of a diameter of a typical pomegranate between the pincher pulley 74 and the rear pulley 76 of the pincher belt 70, so that the pomegranate P of typical size can be completely opened before the pomegranate P reaches the exit E.

Each of the belts 30, 50, 70 can be adjusted in position either by adjusting a position of pulleys upon which the belts 30, 50, 70 are mounted, or with some form of continuous adjustment system, such as spring loaded tensioning systems which would cause the side belt 50 and pincher belt 70 to be encouraged towards each other when the pomegranate P is passing between the two belts, applying a compression force on the pomegranate P. In such an automatically tensioning system, each pomegranate would experience a similar amount of compressing and shearing forces thereon, regardless of the diameter of the pomegranate. As another option, the pomegranates P could be first sized into lots having similar sizes and the machine adjusted for the lot size to be processed.

While the side belt 50 and pincher belt 70 are particularly disclosed as a pair of belts for compressing the pomegranate P and removal of the skin S from components within the core of the pomegranate, the belts could have other configurations and orientations. For instance, such a pair of belts adjacent a gap could be oriented rotating about pulleys mounted upon horizontal axles rather than vertical axles, or in some other orientation other than vertical. While the side belt 50 and pincher belt 70 are shown having bars and slots between adjacent bars, these belts 50, 70 could be only partially foraminous or non-foraminous and still function according to this invention in its preferred configuration as shown. While the pincher belt 70 is shown slightly above the under belt 30 so that these belts 30, 70 do not contact each other, because they are traveling at different speeds, they could contact each other and merely be provided with a lubricant or low friction surfaces that would ride directly over each other.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A processor for removing skins from pomegranates and opening up the pomegranates, such as for aril and juice extraction, the processor comprising in combination:
a first belt adapted to move with a pomegranate adjacent thereto;
a second belt spaced from said first belt by a gap;
said second belt adapted to move separate from said first belt, but in a common direction with said first belt adjacent said gap;
said second belt having a portion thereof closer to said first belt than a width of a pomegranate; and
said second belt moving at a different speed than said first belt at said portion of said second belt where said second belt is closer to said first belt than a width of a pomegranate.

2. The processor of claim 1 wherein said first belt is a side belt spaced horizontally from said second belt by said gap, said side belt at least partially facing said second belt, said side belt and said second belt traveling in a common direction on portions of said side belt and said second belt closest to each other.

3. The processor of claim 2 wherein a third belt is provided, said third belt underlying said gap between said side belt and said second belt, said third belt adapted to carry pomegranates between said side belt and said second belt.

4. The processor of claim 3 wherein said third belt has an upper portion thereof oriented substantially within a horizontal plane, said third belt traveling in a common direction and at a common speed with said second belt.

5. The processor of claim 4 wherein said third belt is formed of a plurality of bars having slots therebetween, said slots large enough to allow arils of the pomegranate to fall through said slots.

6. The processor of claim 5 wherein said third belt has portions thereof resting upon a substantially horizontal deck and portions thereof located below said deck, said deck also supporting said side belt and said second belt thereon with said gap between said side belt and said second belt located over said third belt.

7. The processor of claim 7 wherein portions of said second belt closest to said side belt travel faster than adjacent portions of said side belt.

8. The processor of claim 1 wherein said first belt and said second belt are oriented with portions of said first belt closest to said second belt having a varying distance therebetween with said second belt closest to said first belt at a downstream end of said processor than at an upstream end.

9. The processor of claim 8 wherein both said first belt and said second belt are supported upon pulleys rotated about axes which are all oriented extending substantially vertically.

10. The processor of claim 9 wherein said first belt is supported upon two pulleys.

11. The processor of claim 1 wherein a distance between said first belt and said second belt is less than half the width of an average pomegranate.

12. A machine for peeling a skin from an outer surface of a fruit or vegetable, the machine comprising in combination:
a pair of belts spaced from each other by a gap;
said gap adapted to have at least a portion thereof narrower than a width of the fruit or vegetable; and
said belts traveling in a common direction adjacent said gap and at different speeds, such that sheering forces are applied to surfaces of an item located within said gap and contacting both of said pair of belts.

13. The machine of claim 12 wherein said belts are further apart on an upstream end than on a downstream end.

14. The machine of claim 12 wherein at least one belt is at least partially foraminous and adapted to move under an item within said gap.

15. The machine of claim 14 wherein said at least one belt that is at least partially foraminous includes a plurality of bars spaced apart by slots between said bars.

16. The machine of claim 15 wherein a tray is located under said at least one belt that is at least partially foraminous, said tray adapted to collect portions of said fruit or vegetable falling down through said slots.

17. The machine of claim 16 wherein said pair of belts includes a side belt rotating around pulleys adapted to rotate about vertical axles and a pincher belt adapted to rotate about pulleys having vertically oriented axles, with said gap between said side belt and said pincher belt; and
wherein said at least one belt that is at least partially foraminous is an under belt located under said gap and located around pulleys adapted to rotate around axles extending in a horizontal direction, such that at least portions of said under belt are substantially perpendicular with at least portions of said side belt and said pincher belt.

18. The machine of claim 17 wherein said side belt and said under belt travel at a common speed and said pincher belt travels faster than both said side belt and said under belt.

19. A method for removing arils from a pomegranate, including the steps of:
providing a machine comprising a pair of belts spaced from each other by a gap; the gap adapted to have at least a portion thereof narrower than a width of the fruit or vegetable; and the belts traveling in a common direction at different speeds adjacent the gap, such that sheering forces are applied to surfaces of an item located within the gap and contacting both of the pair of belts;
positioning a pomegranate in the gap with both of the pair of belts contacting the pomegranate;
allowing shear forces from the pair of belts to act on the pomegranate to open the pomegranate, exposing the arils; and
locating a collection region below the gap to collect at least some of the arils.

20. The method of claim 19 wherein said positioning step is preceded by the step of cutting the pomegranate along substantially horizontal planes above and below a midpoint of said pomegranate; and
wherein said positioning step includes the step of placing one of the horizontal surfaces of the pomegranate provided by said cutting step facing downward within the gap and perpendicular to surfaces of the pair of belts.

21. The method of claim 19 including the further step of providing an under belt beneath the gap and transporting the pomegranates upon the under belt through the gap and between the pair of belts.
